(19) United States
(12) Patent Application Publication
(10) Pub. No.: US 2003/0197620 A1
(43) Pub. Date: Oct. 23, 2003

(54) Systems and methods for indicating headset usage

(76) Inventor: Keith H. Radousky, Atlanta, GA (US)

Correspondence Address: NEEDLE & ROSENBERG, P.C., SUITE 1000, 999 PEACHTREE STREET, ATLANTA, GA, 30309-3915, US

(21) Appl. No.: 10/131,727

(22) Filed: Apr. 23, 2002

(51) Int. Cl. G08B 21/00

(52) U.S. Cl. 340/635

(57) ABSTRACT

The present invention is directed to systems and methods for indicating current usage of a headset. A typical system according to the present invention may include one or more indicators perceivable by individuals in proximity to a headset user that provide an indication that the headset is in use. Preferably, the indicators are visual in nature such as lights or physical signs with multiple states. The indicators provide at least two states perceivable to individuals around the headset user. At least one of the states indicates headset usage, and at least one of the states indicates non-use. The transition among states may be accomplished manually by the headset user or automatically through detection of headset use. Some embodiments may further include a power supply while others may draw power from the device to which the headset connects or from the headset itself.

### BACKGROUND

The present invention is directed to systems and methods for indicating that a headset is in current usage. More specifically, without limitation, the present invention relates to systems and methods to locally indicate to other individuals that an individual with a headset is currently using that headset. In addition, the present invention relates to indicating to the headset user that the headset is active.

Many devices today allow a user to receive auditory input and/or output through headsets. FIG. 1 depicts a typical prior art headset. Such devices include without limitation wireless phones, wired phones, transmitting or receiving radios, audio recording and playing devices, entertainment devices, and professional devices. A variety of headset configurations are possible and may include one or more elements such as earpiece 110, earbug, lapel microphone 120, wireless interface such as one utilizing BlueTooth, or any other device used as an interface between individuals and devices such as described above.

When the headset is in use by an individual 140, other individuals 130 in proximity to the headset user are often confused when the headset user either fails to respond when addressed or seems to address another local individual when actually speaking into the headset microphone. Such confusion may be advantageously avoided through use of the systems and methods according to the present invention. Also, users of headsets in public or broadcasted events may be confused as to whether the headset is “live” and “on-the-air”, the present invention provides for indication to the headset user regarding the status of the headset.

### SUMMARY

The present invention is directed to systems and methods for indicating that an individual is engaged in current usage of a headset to other local individuals. The systems and methods according to the present invention include an indicator perceivable by individuals in local proximity to a headset user indicating that the headset is in current use.

In one preferred embodiment, the perceivable indicator may be one or more visual queues that indicate usage of the headset to individuals in local proximity. Visual queues may include lights, gauges or other visually perceivable signals of use. In addition to, or instead of, visual queues, some embodiments may include an auditory indicator perceivable by local individuals; such an auditory indicator preferably is screened from the headset user's perception by auditory input from the headset.

The indicator preferably is automatically activated during headset usage via an activity detector. In other embodiments, the headset user may manually activate the indicator such as via a button, switch, dial or other manual control. Some embodiments may include a manual activation mechanism for overriding automated activity detection.

Additional advantages of the invention will be set forth in part in the description, which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 depicts use of a typical prior art headset.

FIG. 2 depicts a headset equipped with one preferred embodiment of the present invention.

FIG. 3 is a logical block diagram of the components in a preferred embodiment of the present invention.

### DETAILED DESCRIPTION

Exemplary embodiments of the present invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

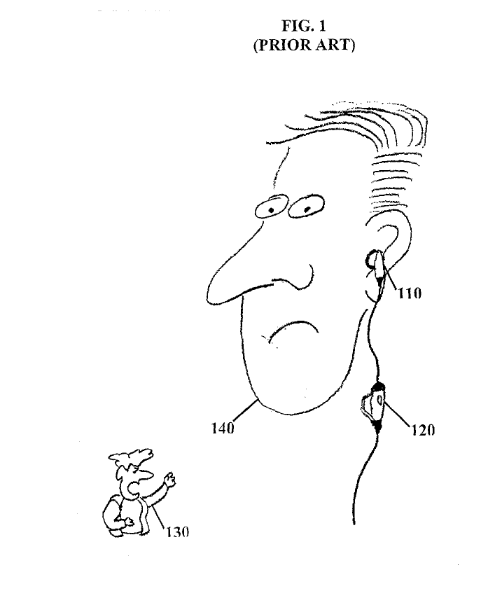

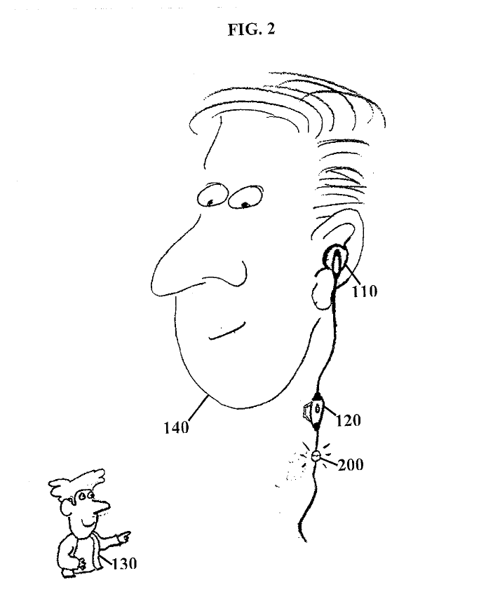

FIG. 2 depicts one preferred indicator system according to the present invention. As compared with FIG. 1, the indicator systems and methods according to the present invention may provide individuals 130 in proximity to the headset user 140 an indication of usage 200. An individual is in proximity to the user if they are positioned close enough to perceive the indicator. Such distance may vary depending upon the indicator type (e.g., light, mechanical sign, audible signal, etc.).

The present invention may use a visual queue such as an illumination device 200 (e.g., a light emitting diode, incandescent lamp or other suitable light source) or a mechanical sign (flags, color coded signs (e.g., green and red), position coded switches or other suitable mechanical visual queue) with one or more states added to a headset such that other local individuals 130 can see the illumination device 200. Some embodiments may use a tactile or audible indicator. In embodiments using an audible indicator, the audible indicator preferably would provide an indication in such a way that the auditory output of the headset would screen the audible indication so as to minimize usability problems for the headset user. Some embodiments may include multiple indicators. In some such embodiments, the multiple indicators may all be of the same type, or may be of varied types.

Activation of the indicator system may be manual or automatic. The manual approach, in one embodiment, could require the headset system to incorporate a simple switch, light and DC power. In the manual approach, the headset user would manual control mechanism such as a switch, button or dial to activate the indicator when that individual is using the headset, thus indicating this fact to other individuals.

Some embodiments may provide an automated approach to activating the indicator. Some such embodiment may further provide for a manual override allowing the user to manually activate or deactivate the indicator. One set of automated embodiments uses a headset system controlled approach. Another set of automated embodiments uses an integrated headset and device-controlled approach.

The pure headset controlled approach embodiments do not require the device to which the headset is connected to have any functionality to control the indicator. In this group, all required functionality to either manually or automatically control the light is self-contained in the headset. This type of system can operate with all currently used devices connecting to headsets.

The second group of embodiments may require that the device provide a control signal and/or power to the headset indicator. The device produces the signal when the device is in use to the headset. The signal may be as simple as providing a ground or supply voltage to the headset only when the device is in use, thus energizing the light when the device is in use.

In some embodiments, the indicator system may be a stand-alone unit that requires no logical and/or physical integration with either the headset or the device to which the headset connects. While in some embodiments, the indicator systems and methods according to the present invention may be physically and/or logically integrated into and/or with existing headset, into and/or with existing devices that connect to headsets or as separate devices physically and/or logically disposed between the device and the headset.

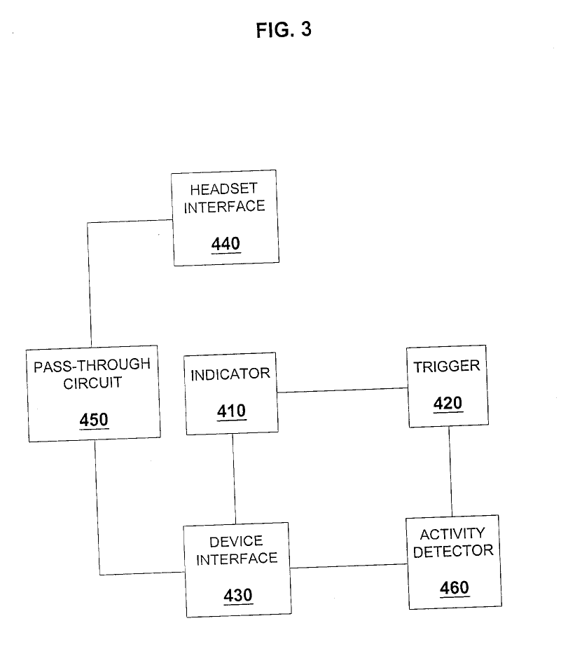

FIG. 3 depicts a block diagram of the logical components of an exemplary system according to one preferred embodiment present invention. Many embodiments do not require all the logical components provided in FIG. 3. Further, the diagram depict logical components; as would be understood by those skilled in the art, particular implementations may integrate the functionality of multiple logical components into one or more physical elements.

Some embodiments of the present inventions include an indicator 410 and a transition trigger 420; additional logical components appearing in FIG. 3 and discussed below may be present in various embodiments. The indicator 410, in some embodiment, may include one or more indicator elements. The indicator 410, or each indicator element, if the indicator 410 includes multiple indicator elements, is perceivable to individuals in proximity to the headset user. The indicator 410 may preferably include one or more visual elements, one or more audible elements or some combination thereof. Visual elements may include lights of various kinds or mechanical signs. Lights and signs can be of any type commonly known to those skilled in the art. Varying colors, on/off states, brightness level, positioning/organization of the light(s) or combinations thereof could represent the various headset activity states. Mechanical signs can be of various types including signs, buttons, gauges, switches, or other suitable mechanical signal. The color, positioning/organization or combinations thereof of the mechanical sign could represent the various headset activity states.

Audible indicators (or indicator elements) may vary on/off states, tone, tone patters or combinations thereof to represent various headset use states. In embodiments, using indicators having at least one audible element, the auditory signal is preferably generated in such a way as to minimize impact on the headset user.

The indicator may transition between multiple states representing different states of headset activity. At least one of the states corresponds to an active state indicating current use of the headset. At least one of the states corresponds to an inactive state indicating no current use of the headset. Additional indicator states may be provided to indicate different modes of headset use or non-use. For instance, the headset connected to a mobile phone might use an indicator system having one light with three-color states or three separate colored lights—green light on, yellow light on or red light on. Green could indicate no current use of the headset. Yellow could indicate establishing a connection, and red could indicate current headset use.

Some embodiments may further provide an indication that a headset is not only in use but also “live” and connected to a communications network such as radio broadcast, public announcement system or local speech amplification system. Such an indication may include a separate state of the indicator corresponding to the “live” state of the headset; for instance, in an embodiment using a light as an indicator, off could correspond to no use, on to current use and blinking to use and “live”. Alternatively, multiple indicator elements could be used to indicate use and “live” respectively.

In the instance where the indictor includes one or more lights that each only support on and off states, the active state preferably corresponds to the on state of such lights, and the inactive state preferably corresponds to the off state of such lights. Other embodiments may reverse the assignment of indicator on and off states to respectively the inactive and active states.

In some embodiments, the system may further require a device interface 430 and/or a headset interface 440. Such interfaces may use any suitable technique for allowing communication between the system and the device and/or headset; such technique's may include hard wired connectivity (e.g., system integrated with device or headset), suitable male or female ports adapted to connect with the device, the headset or both or a wireless transmitter and/or receiver system. Where the system is integrated with device or headset, the interface may be shared with the device and/or headset as appropriate.

In certain embodiments, the system may include a power source (not shown). Such a power source may be rechargeable or allow for insertion of suitable disposable and/or rechargeable battery storage cells. In some embodiments, power may be supplied to the device via a device interface 430 and/or a headset interface 440 when such interfaces are actually physically to the device and/or headset respectively.

In embodiments having both a device interface 430 and a headset interface 440, the system may further include a pass-through circuit 450 that passes signals between the device interface 430 and the headset interface 440. In some such embodiments the pass-through circuit may be incorporated into one or both of the indicator 410 and the transition trigger 420. The pass-through circuit in some embodiments may further provide signal amplification and/or filtering.

The transition trigger 420 may provide manual, automatic or both manual and automatic triggering of indicator state transitions. In a manual approach, the trigger 420 may include a switch, a button, a dial or other suitable mechanical control mechanism. In some automatic approaches, the device interface 430 and/or headset interface 440 may be necessary for automatic state transitioning.

In some such embodiments, the system may further include a headset activity detector 460. The activity detector 460 may be separate, or preferably integrated with the transition trigger 420. Alternatively, the activity detector 460 may be integrated in the device interface 430 or the headset interface 440 in embodiments having one or both of these interfaces. Finally, the activity detector 460 could be integrated with the indicator.

In other embodiments, the activity detector need not be part of the system but may reside in either the device or the headset. In such embodiments, the activity detector could provide the system with a control signal directed to the transition trigger via the device or headset interface as appropriate.

In some embodiments, the activity detector may be a voice activity detector as would be known to those skilled in the art. In other embodiments, the activity detector may base its determination on characteristics of a signal generated by the headset or the device as appropriate.

Another activity detector instead of, or in addition to, those above may be a wireless or wired signal from the control room (to the headset which enables indicator) of a broadcast studio, concert, seminar, ceremony, or any other event in which an individual using a headset would benefit from visual confirmation that the headset is connected and “live”. This embodiment expands the application of the present invention to indication of headset activity to the headset user that his/her headset is “live” and “on-the air”. This application may be useful in preventing headset users from either speaking prior to the headset being “live” or speaking when the user believes the headset ISN'T live when in fact the headset is “live”.

The activity detector in some embodiment may include a timing circuit that would delay triggering a transition when it detects inactivity of the headset in order to compensate for errors in detected activity. For example, a three second pause in conversation may be required before the activity detector causes the transition trigger to transition the indicator to the inactive state. The time delay may be a fixed or configured amount. Alternatively, the timing circuit may dynamically determine the delay based upon the determined behavior of the headset user.

In an exemplary process according to the present invention, current use state of a headset is determined. Based upon the determined use state, an indicator such as a light perceivable by individuals in local proximity to the headset user is transitioned among perceivably different states wherein each perceivably different state corresponds to a current use state of the headset. The determination of current use state may result from a manual or automatic approach. In the instance of a light, the light may be transitioned to an on state when the headset is in use and transitioned to an off state when the headset is not in use.

In some embodiment having an automated approach, a manual override may be provided as part of the activity detector implemented as a mechanical switch, button, dial or other suitable mechanism

Throughout this application, various publications may have been referenced. The disclosures of these publications in their entireties are hereby incorporated by reference into this application in order to more fully describe the state of the art to which this invention pertains.

The embodiments described above are given as illustrative examples only. It will be readily appreciated by those skilled in the art that many deviations may be made from the specific embodiments disclosed in this specification without departing from the invention. Accordingly, the scope of the invention is to be determined by the claims below rather than being limited to the specifically described embodiments above.

What is claimed is:

1. A system for indicating usage state of a headset in connection with a device that sends or receives auditory signals to or from the headset, the system comprising:
a) an indicator perceivable by individuals in local proximity to a headset user wearing a headset connected to a device, wherein the indicator may transition between a plurality of perceivably differing states, wherein at least one of the plurality of states corresponds to an active state of the headset and wherein at least one of the plurality of states corresponds to an inactive state of the headset; and
b) a transition trigger that causes the indicator to transition between states in the plurality of states.

2. The system of claim 1, wherein the indicator comprises a plurality of indicator elements.

3. The system of claim 2, wherein at least one of the plurality of indicator elements is visually perceivable by individuals in local proximity to the headset user.

4. The system of claim 3, wherein the at least one visually perceivable indicator element is a light or a mechanical sign.

5. The system of claim 2, wherein at least one of the plurality of indicator elements is audibly perceivable by individuals in local proximity to the headset user.

6. The system of claim 1, wherein the indicator is audibly perceivable by individuals in local proximity to the headset user.

7. The system of claim 1, wherein the indicator is visually perceivable by individuals in local proximity to the headset user.

8. The system of claim 7, wherein the indicator is a light or a mechanical sign.

9. The system of claim 1, wherein the transition trigger is manually operated by the headset user to cause the indicator to transition between states.

10. The system of claim 9, wherein the transition trigger comprises a switch, a button or a dial.

11. The system of claim 1, and further comprising a device interface adapted to connect the system with the device, wherein the indicator is capable of drawing power from the device when connected via the device interface.

12. The system of claim 11, and further comprising a headset interface adapted to connect the system with the headset and a pass-through circuit that passes signals between the device interface and the headset interface.

13. The system of claim 1, and further comprising a device interface adapted to connect the system with the device and a headset activity detector capable of detecting headset usage based upon signals from the device when connected via the device interface and capable of activating the transition trigger based upon detected activity.

14. The system of claim 13, wherein the transition trigger comprises a manually operated override to cause the indicator to transition between states, thereby overriding activation by the headset activity detector.

15. The system of claim 13, and further comprising a headset interface adapted to connect the system with the headset and a pass-through circuit that passes signals between the device interface and the headset interface.

16. The system of claim 13, wherein the indicator is capable of drawing power from the device when connected via the device interface.

17. The system of claim 13, wherein the headset activity detector comprises a timing circuit that activates the transition trigger after an amount of time where no headset activity is detected.

18. The method of claim 17, wherein the amount of time is a predetermined amount of time.

19. The system of claim 13, wherein the device interface supports wireless connectivity between the system and the device.

20. The system of claim 1, and further comprising a headset interface adapted to connect the system with the headset, wherein the indicator is capable of drawing power from the headset when connected via the headset interface.

21. The system of claim 1, and further comprising a headset interface adapted to connect the system with the headset and a headset activity detector capable of detecting headset usage based upon signals from the headset when connected via the headset interface and capable of activating the transition trigger based upon detected activity.

22. The system of claim 21, wherein the transition trigger comprises a manually operated override to cause the indicator to transition between states, thereby overriding activation by the headset activity detector.

23. The system of claim 21, wherein the indicator is capable of drawing power from the headset when connected via the headset interface.

24. The system of claim 21, wherein the headset activity detector comprises a timing circuit that activates the transition trigger after an amount of time where no headset activity is detected.

25. The system of claim 24, wherein the amount of time is a predetermined amount of time.

26. The system of claim 21, wherein the headset interface supports wireless connectivity between the system and the headset.

27. The system of claim 1, and further comprising a power source.

28. The system of claim 27, wherein the power source is rechargeable.

29. The system of claim 27, wherein the power source is adapted to receive one or more disposable batteries.

30. The system of claim 1, wherein the system is mounted in the device.

31. The system of claim 1, wherein the system is mounted in the headset.

32. A method of indicating headset usage to individuals in proximity to a headset user, the method comprising:
a) detecting a use state of a headset connected to a device that sends audio signals to or receives such signals from a headset worn by a headset user;
b) activating a light perceivable by individuals in local proximity to the headset user when the detected active use state indicates active current use of the headset; and
c) deactivating the light when the detected active use state indicates no current use of the headset.

33. A system for indicating usage state of a headset in connection with a device that sends or receives auditory signals to or from the headset, the system comprising:
a) indicator means for indicating active or inactive status of a headset connected to a device to individuals in local proximity to a headset user wearing the headset, wherein the indicator may transition between a state corresponding to active status and a state corresponding to inactive status;
b) power means for conveying power to the indicator means;
c) transitioning means for triggering the indicator means to transition between states; and
d) detecting means for detecting an active use state of the headset and for activating the transitioning means based upon the detected active use state.

34. The system of claim 33, wherein the detecting means comprises timing means for activating the transitioning means after a predetermined amount of time where no headset activity is detected.
